(19) United States
(12) Patent Application Publication
(10) Pub. No.: US 2017/0055806 A1
(43) Pub. Date: Mar. 2, 2017

(54) FOOTWEAR CLEANER

(71) Applicant: Myron Badry, Camrose (CA)

(72) Inventor: Myron Badry, Camrose (CA)

(21) Appl. No.: 14/839,797

(22) Filed: Aug. 28, 2015

(51) Int. Cl. A47L 23/26; B25G 1/10

(52) U.S. Cl. CPC A47L 23/26; B25G 1/10

(57) ABSTRACT

An apparatus for cleaning the bottoms of footwear comprises a substantially planar grate having top and bottom surfaces and a plurality of openings therethrough, at least two supports secured to the bottom surface of the grate so as to space the grate above a surface and a brush having a plurality of bristles located on the top surface of the grate having the bristles extending substantially away from the grate.

### BACKGROUND OF THE INVENTION

1. Field of Invention The present invention relates generally to cleaning in general and in particular to an apparatus for cleaning the bottoms of footwear.

2. Description of Related Art

In many locations, it is desirable to removed dirt or other contaminants from the bottom a person's footwear. In particular, boots and in particular work boots are known to become quite dirty on a bottom thereof. Conventional methods of cleaning boot have been inadequate.

In particular, conventional mats comprise flat planar members having roughed surfaces upon which a user may scrape or draw their foot so as to cause the mat to scrape or otherwise remove debris from the bottom of a user's footwear. Disadvantageously, as the cleaning surface of such a mat is the mat itself, any debris removed by the matt will remain upon the mat. This becomes particularly disadvantageously where the user's footwear is heavily soiled such that a large amount of debris accumulates thereupon limiting the future effectiveness of the mat.

### SUMMARY OF THE INVENTION

According to a first embodiment of the present invention there is disclosed an apparatus for cleaning the bottoms of footwear comprising a substantially planar grate having top and bottom surfaces extending between front and rear edges and having a plurality of openings therethrough. The apparatus further comprises at least two supports secured to the bottom surface of the grate so as to space the grate above a surface and a brush having a plurality of elongate bristles located on the top surface of the grate having the bristles extending substantially away from the grate.

The grate may be formed of metal. The grate may include serrated top edges. The at least two supports may comprise beams. The beams may be located below first and second side edges of the grate. The support beams may have a height of between 1 and 4 inches. The beams may include bores through side surface thereof for connection to beams of adjacent cleaning apparatuses. The beams may include bores through a bottom surface for connection to a support surface.

The beams may include rollers along a bottom thereof. The beams may include feet along a bottom thereof. The feet may include rubberized bottom surfaces.

The plurality of openings may have a width of between ½ and 1 inch. The brush may include a rigid member secured to the grate. The elongate bristles may have a length of at least 2 inches.

The apparatus may further comprise a handle extending from the grate. The handle comprises an A-shaped member. The horizontal portion has a height between 2 and 5 feet above the grate.

The apparatus may further comprise a catching tray sized to be received below the grate between the at least two supports. The catching tray may include a portion sized to extend past the rear edge of the grate.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective view of an apparatus for cleaning a user's footwear according to a first embodiment of the present invention.

FIG. 2 is a cross sectional view of the apparatus of FIG. 1 as taken along the line 2-2 as used in a first step.

FIG. 3 is a cross sectional view of the apparatus of FIG. 1 as taken along the line 2-2 as used in a second step.

### DETAILED DESCRIPTION

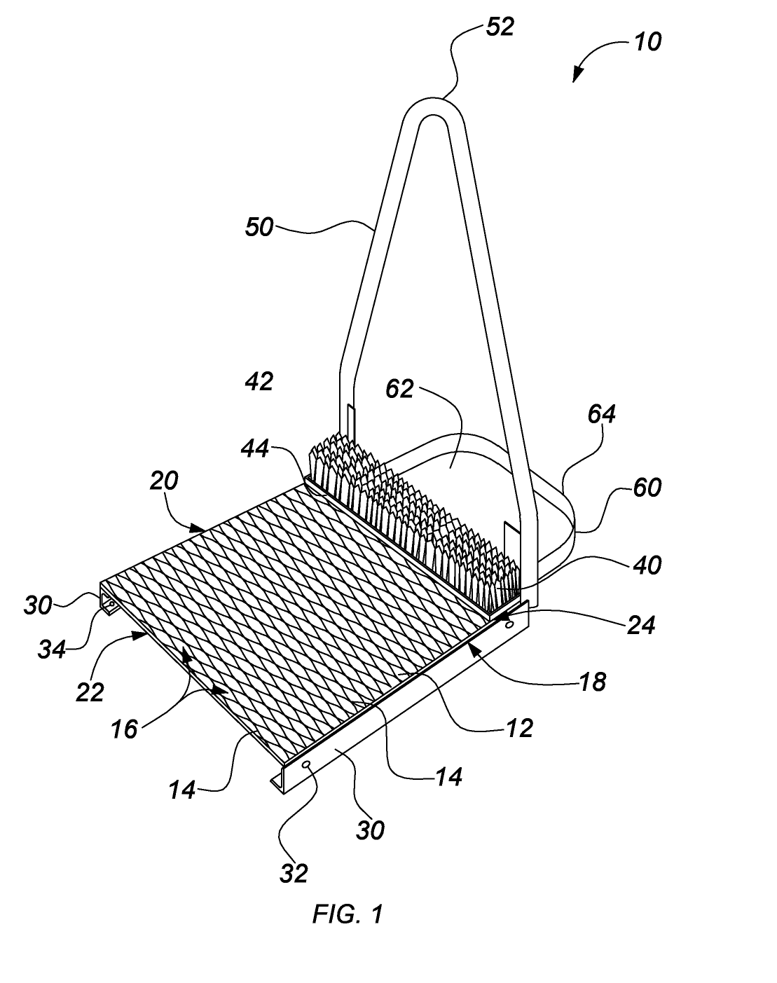

Referring to FIG. 1, an apparatus for cleaning the bottom of a user's footwear according to a first embodiment of the invention is shown generally at 10. The apparatus comprises a grate 12 spaced above the floor or ground upon which it is placed and a plurality of associated bristles 40 located thereon. In use, the grate 12 may be utilized to remove larger material from the footwear whereafter the bristles 40 may be utilized to remove smaller particles as will be more fully described below.

The grate 12 comprises a sheet of planar material formed of a plurality of rigid members 14 having gaps 16 therebetween. It will be appreciated that the grate 12 may be of any conventional type, such as, by way of non-limiting example, perforated sheet metal, anti-slip grating and may have openings of any known shape such as, by way of non-limiting example, diamond shaped, round, rectangular, triangular or the like. The gaps 16 or openings will be selected to have a width adequate to permit material to be removed from the user's footwear to pass through the grate. By way of non-limiting example, it has been found that a width of between ½ and 1 inch has been useful although it will be appreciated that other widths may be useful as well. optionally the rigid members 14 may have serrations or other profiles on the top edge thereof to provide a roughened surface for contact with a user's footwear as will be more fully described below.

The grate 12 extends between first and second side edges, 18 and 20, respectively and front and rear edges, 22 and 24 respectively. The grate 12 has dimensions selected to permit a user to stand thereon such as having a width between the first and second side edges and a depth between the front and rear edges 22 and 24 of between 18 and 30 inches(457 to 762 mm). The grate 12 includes at least two support beams 30 located under the first and second side edges 18 and 20 so as to space the grate 12 above the floor 8 or other surface upon which it is located. As illustrated in FIG. 1, the beams 30 may comprise c-shaped channels although it will be appreciated that other beam type may also be utilized such as, by way of non-limiting example, box or I-beam.

The beams 30 are selected to space the grate 12 above the floor 8 by a distance sufficient to permit dirt and other debris removed from the user's shoes to be accumulated thereunder without interfering with the operation of the grate 12. By way of non-limiting example, the beams may have a height of between 1 and 3 inches (25 and 76 mm) although it will be appreciated that other dimensions may be useful in some situations as well. The beams 30 and grate 12 may be formed of any suitably hard and rigid material, such as, by way of non-limiting example, steel, stainless steel or composite materials. In particular, the grate 12 should be selected to provide sufficient strength to support the weight of a user thereon. As illustrated in FIG. 1, the beams 30 and the grate 12 may be formed separately from each other, however it will be appreciated that they may also be co-formed with each other from a continuous sheet of bent metal. Where the beams 30 are formed separately from the grate 12, the grate may be secured thereto through any know means, such as, by way of non-limiting example, welding, adhesives or fasteners. As illustrated in FIG. 1, the beams 30 may include horizontal bores 32 extending therethrough for securing one or more adjacent apparatuses together or vertical bores 34 for securing the apparatus to the floor with fasteners or the like.

As illustrated in FIG. 1, the bristles 40 extend from the top of the grate proximate to the rear edge thereof so as to have free distal ends 42 located thereabove. The bristles 40 are suitably elongate so as to ensure that any material removed thereby from a user's shoes will not be retained proximate to the distal ends 42. In such a manner, the material removed from a user's shoes will be removed from the location of the user's shoes and thereby will not become reattached to the recently cleaned shoe. The bristles 40 may be formed of any suitably stiff material such as, plastic or metal. The bristles 40 extend from and main be supported and contained by a base member 44. The base member 44 may be of any suitable type such as wood, plastic or the like and may contain and support the bristles 40 in any known fashion such as within bores or embedding the bristles therein as is commonly known. As illustrated in FIG. 1, the base 4 may be secured to the top of the grate 12 so as to position the bristles thereabove. The base member 44 may be secured to either the grate 12 or the beams 30 and may be secured thereto through any commonly known method such as adhesives, welding or fasteners.

In operation, a user may utilize the apparatus as described above to remove dirt and debris from the bottom of the footwear. In operation, the user may stand upon the grate 12 and rub or otherwise move their feet relative to the grate 12 so as to cause the top edges of the rigid members 14 to remove larger material therefrom. Thereafter, the user may then rub or otherwise move their feet relative to the bristles so as to cause the free distal ends 42 of the bristles 40 to further remove smaller material as well as materials located between the grips of their footwear therefrom.

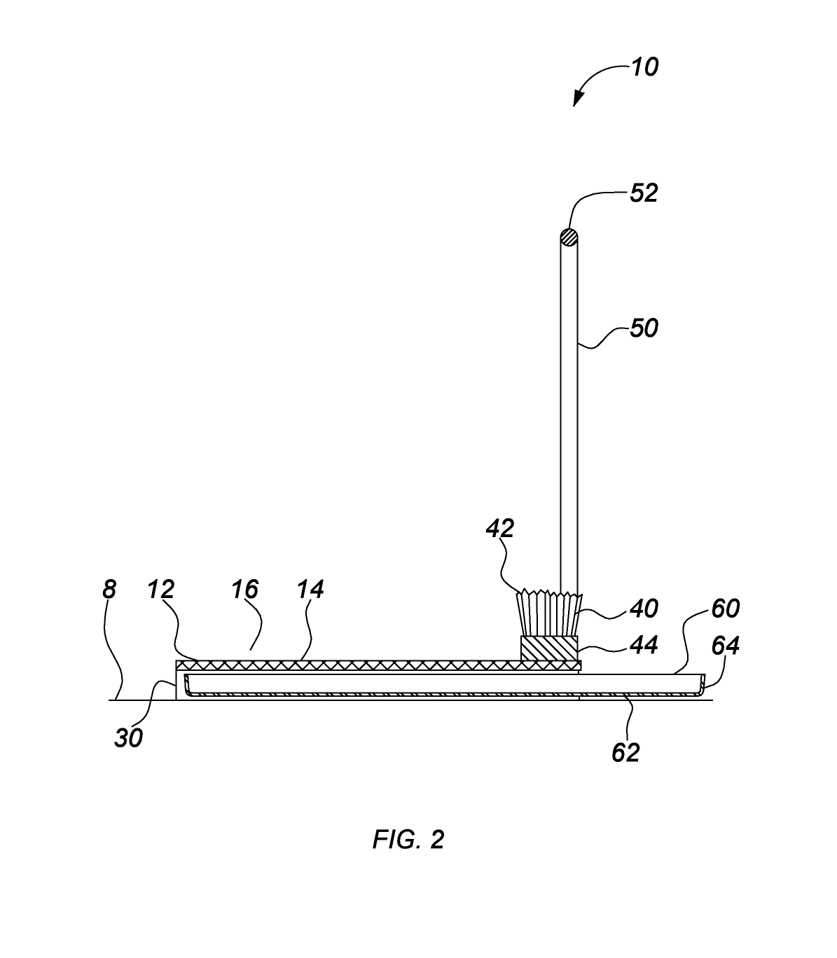

Optionally, the apparats may include a handle 50 extending upwardly therefrom proximate to the rear edge 4. The handle 50 comprises a substantially a-frame shaped member having a top end 52. The handle 50 may have a height selected to permit a user to grasp it so as to stabilize themselves during use of the apparatus. Additionally, as illustrated in FIGS. 1 and 2, the apparatus may include a tray 60 located thereunder. The tray 60 may be sized to correspond to the grate 12 and may include an extended portion 66 extending past the rear edge 24 thereof. The extended portion 66 may extend past the rear edge 24 by a distance sufficient to catch material ejected from the bristles 40 as the user brushes there footwear therepast, such as, by way of non-limiting example, between 16 and 20 inches (406 and 508 mm). The tray 60 includes a bottom pan member 62 and an upturned wall 64 extending therearound. The tray 60 provides a receptacle to catch dirt and debris removed from the user's shoes by the grate 12.

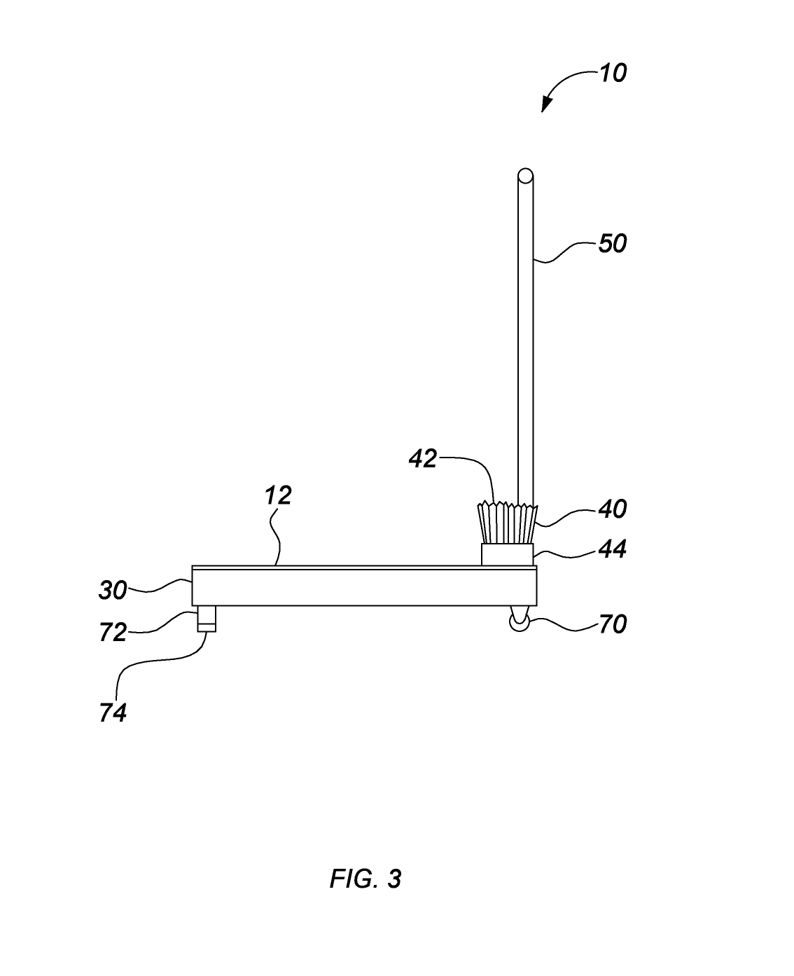

As illustrated in FIG. 3, the apparatus may optionally include one or more rollers 70 located along the bottom thereof to assist in repositioning the apparatus. As illustrated, the rollers 70 may be located proximate to the rear edge 24 of the grate 12 although it will be appreciated that other locations may be utilized as well. The apparatus 10 may also include one or more feet 72 extending from the bottom thereof sized to cooperate with the rollers 70 to provide a stationary support at a positioned desired by a user. The feet 72 may include rubberized or other suitable non-slip bottom surfaces 74 thereon.

While specific embodiments of the invention have been described and illustrated, such embodiments should be considered illustrative of the invention only and not as limiting the invention as construed in accordance with the accompanying claims.

What is claimed is:

1. An apparatus for cleaning the bottoms of footwear comprising:
a substantially planar grate having top and bottom surfaces extending between front and rear edges and having a plurality of openings therethrough;
at least two supports secured to said bottom surface of said grate so as to space said grate above a surface; and
a brush having a plurality of elongate bristles located on said top surface of said grate having said bristles extending substantially away from said grate.

2. The apparatus of claim 1 wherein said grate is formed of metal.

3. The apparatus of claim 1 wherein said grate includes serrated top edges.

4. The apparatus of claim 1 wherein said at least two supports comprise beams.

5. The apparatus of claim 4 wherein said beams are located below first and second side edges of said grate.

6. The apparatus of claim 4 wherein said support beams have a height of between 1 and 4 inches.

7. The apparatus of claim 4 wherein said beams include bores through side surface thereof for connection to beams of adjacent cleaning apparatuses.

8. The apparatus of claim 4 wherein said beams include bores through a bottom surface for connection to a support surface.

9. The apparatus of claim 1 wherein said beams include rollers along a bottom thereof.

10. The apparatus of claim 1 wherein said beams include feet along a bottom thereof.

11. The apparatus of claim 10 wherein said feet include rubberized bottom surfaces.

12. The apparatus of claim 1 wherein said plurality of openings have a width of between ½ and 1 inch.

13. The apparatus of claim 1 wherein said brush includes a rigid member secured to said grate.

14. The apparatus of claim 1 wherein said elongate bristles have a length of at least 2 inches.

15. The apparatus of claim 1 further comprising a handle extending from said grate.

16. The apparatus of claim 15 wherein said handle comprises an A-shaped member.

17. The apparatus of claim 16 wherein said horizontal portion has a height between 2 and 5 feet above said grate.

18. The apparatus of claim 1 further comprising a catching tray sized to be received below said grate between said at least two supports.

19. The apparatus of claim 18 wherein said catching tray includes a portion sized to extend past said rear edge of said grate.
